(19) United States
(12) Patent Application Publication
(10) Pub. No.: US 2009/0267011 A1
(43) Pub. Date: Oct. 29, 2009

(54) Dispensing valve assembly

(76) Inventors: Jason Hatton, Essexville, MI (US); James P. Manning, Sanford, MI (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/148,923

(22) Filed: Apr. 23, 2008

(51) Int. Cl. F16K 31/44

(52) U.S. Cl. 251/279

(57) ABSTRACT

A dispensing valve assembly is configured to control flow from an associated container or like reservoir, and includes a dispensing valve body configured for connection to the associated container. The valve assembly includes a resiliently deformable valve member, positioned within the valve body, for controlling flow therethrough. Selective opening of the valve member is effected by the provision of a reciprocably movable actuation member, positioned generally within the valve body, which can be actuated to bear against and engage the valve member to move the valve member from its closed configuration to its open configuration. An actuation button, provided on the exterior of the valve body, is engageable with the internal actuation member to permit convenient operation of the valve assembly.

### TECHNICAL FIELD

This invention relates to a valve assembly for dispensing a fluent substance from an associated container or like reservoir, and more particularly to a valve assembly which includes an elastomeric flow-controlling valve, and an actuating member engageable with the valve for selectively controlling flow through the assembly.

### BACKGROUND OF THE INVENTION AND TECHNICAL PROBLEMS POSED BY THE PRIOR ART

The inventors of the present invention have discovered that it would be advantageous to provide an improved system for dispensing a fluent product, including liquid. In particular, the inventors have discovered an innovative design that provides advantages not heretofore contemplated in the packaging industry or suggested by the prior art.

### SUMMARY OF THE INVENTION

The inventors of the present invention has invented an innovative dispensing valve assembly which, inter alia, can advantageously employed for conveniently dispensing a liquid or like fluid substance from an associated container or other reservoir.

In accordance with the present invention, a dispensing valve assembly is disclosed which is configured for controlling flow from an associated container or other reservoir. The present dispensing valve assembly is desirably straightforward in configuration for economical manufacture, and reliable, consistent operation, and includes a dispensing valve body which can be configured to define first and second internal flow passages joined in fluid communication with each other for receiving fluid from the associated container. In one illustrated embodiment, the valve body includes a connecting collar for connection to the associated container, with the first internal flow passage extending through the connecting collar. The valve body further defines a flow discharge opening of the valve body through which liquid can flow from within the valve assembly.

Control of fluid flow is effected by the provision of a flow-control valve member positioned within the dispensing valve body by disposition between the valve body, and an associated valve retaining member, which is preferably snap-fit with the valve body so that the valve member is held in captive relationship therebetween. Notably, the valve member is preferably provided in the form of a resilient, elastomeric self-closing valve element. The valve member controls flow within the valve body and out of the valve body through the flow discharge opening.

In accordance with the illustrated embodiments, the valve member includes a peripheral attachment portion by which the valve member can be attached to the dispensing valve body, by disposition of the peripheral attachment portion between the valve retaining member and the valve body. The valve member further includes a flexible, resilient, intermediate portion extending from the peripheral portion, which in one illustrated embodiment, comprises a rolling, invertible sleeve.

The valve member further includes a central valve head, extending from the intermediate portion of the valve member, with at least part of the valve head being outwardly deflectable from a closed configuration to an open configuration of the valve member. Control through the valve is achieved by the provision of at least one elongate slit defining at least two, deformable, openable regions of the valve head of the valve member. Each deformable region (1) has at least one transverse face for sealing against a transverse face of another one of the openable regions, and (2) is normally closed but can open to permit flow therethrough.

In accordance with the present invention, the present dispensing valve assembly includes an actuation member positioned within the valve body for reciprocating movement with respect to the valve body. In one illustrated embodiment, the actuation member is provided within the second internal flow passage of the valve body.

The actuation member is engageable with the valve head of the valve member for moving the valve head from the closed configuration to the open configuration of the valve. Notably, opening of the valve member in this fashion is achieved without directly connecting the actuation member to the valve member, but rather, simply by engagement of the actuation member with an inwardly facing surface of the valve member.

Actuation in this manner acts to deflect the valve head of the valve member so that the deformable regions thereof move away from each other to define a flow passage through the valve head of the valve member. In one illustrated embodiment, wherein the valve member includes an intermediate portion in the form of a rolling, invertible sleeve, the valve member generally deforms and inverts, in a direction generally outwardly of the valve assembly, to thereby permit liquid flow through the valve assembly and out of the flow discharge opening. In an alternate embodiment, wherein the valve member of the valve assembly is positioned generally upstream of the valve actuation member, the valve member is maintained in a non-inverted configuration.

In the preferred form, the dispensing valve assembly includes an actuation button provided on the exterior of the valve body, which is engageable with the internally-positioned actuation member. By this arrangement, manipulation of the actuation button reciprocably moves the actuation member to act against the valve member, to thereby move the valve member from the closed configuration to the open configuration thereof. The actuation button is preferably provided with a generally dome-like configuration, and is preferably formed from flexible, resilient material, so that upon release of the actuation button, the button resumes its original configuration, and the internal actuation member reciprocates within the valve assembly, as the valve member returns to its closed configuration. Liquid flow through the valve assembly is thus terminated, with the self-closing nature of the preferred valve member of the assembly desirably acting to block and prevent flow of liquid through the assembly.

In one illustrated embodiment, the actuation member includes a head portion engageable with the valve member, with the head portion defining at least one flow passage to permit flow from within the valve body, through the head portion, and through the valve member in the open configuration thereof. In this embodiment, the actuation member of the valve assembly is positioned generally upstream of the deformable valve member, with liquid passing first through the flow port in the head portion of the actuation member, and then through the deformable valve member. In an alternate embodiment, wherein the valve actuation member is arranged for generally horizontal, reciprocable movement, the valve member is positioned generally upstream of the actuation member, with liquid flowing through the valve member, then through the flow port of the head portion of the actuation member, and out of the discharge opening of the valve body.

The inventors of the present invention have discovered that the dispensing valve assembly components can optionally be designed for easily accommodating the assembly of the components during manufacture of the valve assembly.

Also, the dispensing valve assembly can optionally be provided with a design that accommodates efficient, high quality, large volume manufacturing techniques with a reduced product reject rate.

Numerous other advantages and features of the present invention will become readily apparent from the following detailed description of the invention, from the claims, and from the accompanying drawings.

### BRIEF DESCRIPTION OF THE DRAWINGS

In the accompanying drawings forming part of the specification, in which like numerals are employed to designate like parts throughout the same.

FIG. 1 is an exploded, isometric view of a dispensing valve assembly embodying the principles of the present invention;

FIG. 2 is a cross-sectional view of the present dispensing valve assembly, illustrating the assembly in a closed configuration;

FIG. 3 is a side elevational view of a valve member of the present valve assembly;

FIG. 4 is a top plan view of the valve member shown in FIG. 3;

FIG. 5 is a perspective view illustrating the interior of the valve member shown in FIGS. 3 and 4;

FIG. 6 is a fragmentary, relatively enlarged cross-sectional view illustrating the valve member of the present valve assembly in an open configuration;

FIG. 7 is a front elevational view of an alternate embodiment of the present dispensing valve assembly; and

FIG. 8 is a cross-sectional view, taken generally along lines 8-8 of FIG. 7, of the alternate embodiment of the present valve assembly.

### DESCRIPTION OF THE PREFERRED EMBODIMENTS

While this invention is susceptible of embodiment in many different forms, this specification and the accompanying drawings disclose only one specific form as an example of the invention. The invention is not intended to be limited to the embodiment so described, however. The scope of the invention is pointed out in the appended claims.

For ease of description, many of the figures illustrating the invention show a dispensing valve assembly in one preferred form of a dispensing system in the typical orientation that the system has when installed the valve assembly on one type of container or reservoir which is stored upright on its base, and terms such as upper, lower, horizontal, etc., are used with reference to this position. It will be understood, however, that the dispensing valve assembly of this invention may be manufactured, stored, transported, and sold in an orientation other than the orientation described.

The dispensing valve assembly of this invention is suitable for use with a variety of conventional or special fluent substance holding systems, including containers, tanks, vessels, and other equipment or apparatus, the details of which, although not fully illustrated or described, would be apparent to those having skill in the art and an understanding of such fluent substance holding systems. Such a fluent substance holding system, or portion thereof, with which the inventive dispensing valve assembly cooperates is hereinafter simply referred to as a “reservoir”. The particular reservoir, per se, that is illustrated and described herein forms no part of, and therefore is not intended to limit, the broad aspects of the present invention. It will also be understood by those of ordinary skill that novel and non-obvious inventive aspects are embodied in the described exemplary dispensing system alone.

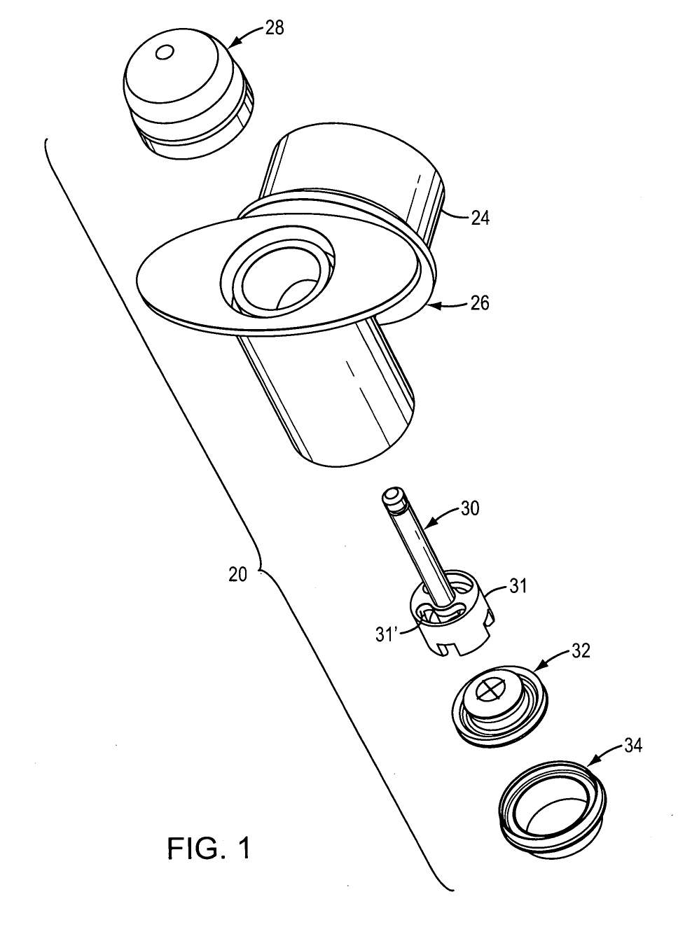

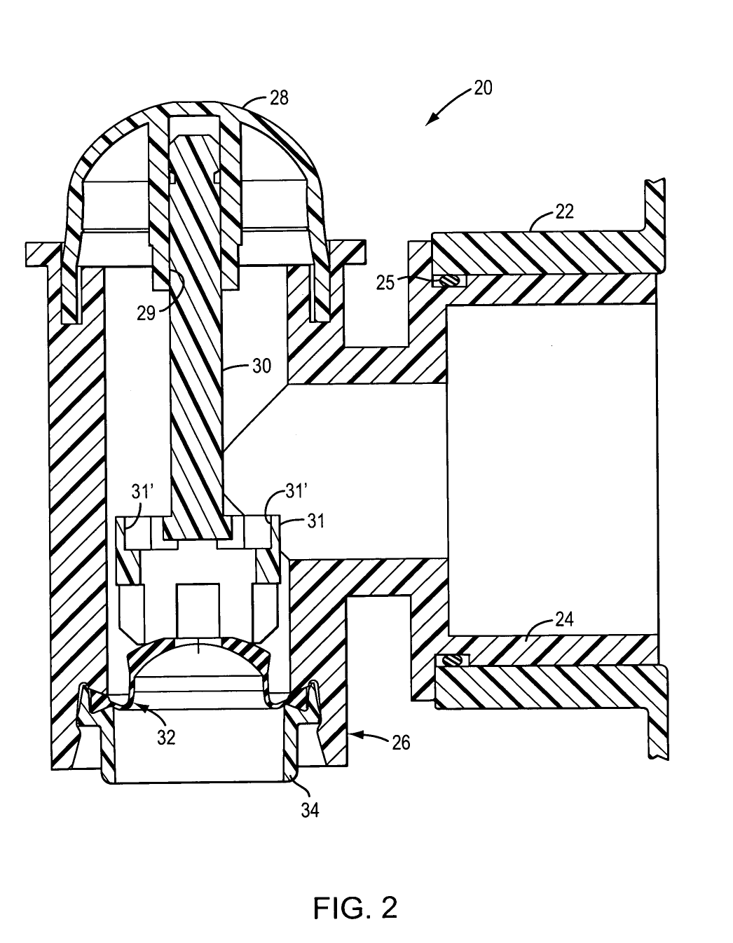

A first embodiment of a dispensing valve assembly of the present invention is illustrated in FIGS. 1-6 and is designated generally in many of those figures by reference number 20 (e.g., in FIG. 1). In the preferred embodiment illustrated, the dispensing valve assembly 20 is provided in the form of components that are initially made and assembled, and that are subsequently mounted or installed on a container or like reservoir (for example, the container 22 shown in FIG. 2) for containing a liquid or other fluent substance.

As can be seen in FIGS. 1 and 2, the presently preferred form of the dispensing valve assembly 20 includes the following basic components which are assembled together: (1) a connecting collar 24, (2) a washer 25 for coacting with the collar 24, (3) a conduit or hollow valve body 26 attached to the container 22 with the collar 24, (4) a flexible, resilient actuation button or dome 28 on the valve body 26, (5) an internal, rod-like actuation member 30 disposed within the body 26, (6) a dispensing valve member 32 mounted in the body 26, and (7) a valve retaining member or clamp member 34, in the form of a retaining ring in this embodiment, that retains the valve member 32 in the body 26.

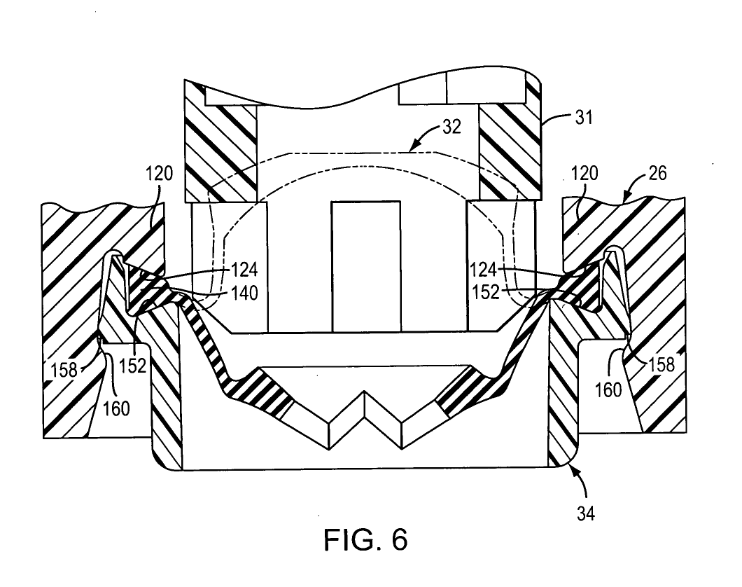

The valve body 26 has an outlet or discharge opening defined by an annular wall portion 120 (FIG. 6) that defines an annular seat 124, preferably in the configuration of a frustoconical surface, for receiving a peripheral portion of the valve member 32 as described hereinafter. This accommodates the seating of the valve member 32 in the body 26 adjacent the outlet. The surface or seat 124 functions as an annular, downwardly angled clamping surface for sealingly engaging the peripheral part of the valve member 32 when the valve member 32 is retained in the body 26 by means of the retaining ring 34 as described in detail hereinafter.

The preferred embodiment of the valve member 32 is a self-closing, slit-type valve. The valve member 32 is preferably molded as a unitary structure from material which is flexible, pliable, elastic, and resilient. This can include elastomers, such as a synthetic, thermosetting polymer, including silicone rubber, such as the silicone rubber sold by Dow Corning Corp. in the United States of America under the trade designation D.C. 99-595-HC. Another suitable silicone rubber material is sold in the United States of America under the designation Wacker 3003-40 by Wacker Silicone Company. Both of these materials have a hardness rating of 40 Shore A. The valve member 32 could also be molded from other thermosetting materials or from other elastomeric materials, or from thermoplastic polymers or thermoplastic elastomers, including those based upon materials such as thermoplastic propylene, ethylene, urethane, and styrene, including their halogenated counterparts.

In the preferred embodiment illustrated, the valve member 32 has the configuration of a commercially available valve substantially as disclosed in the U.S. Pat. No. 5,676,289 with reference to the valve 46 disclosed in the U.S. Pat. No. 5,676,289. Such a type of valve is further described with reference to the similar valve that is designated by reference number 3d in the U.S. Pat. No. 5,409,144. The descriptions of those two patents are incorporated herein by reference thereto to the extent pertinent and to the extent not inconsistent herewith.

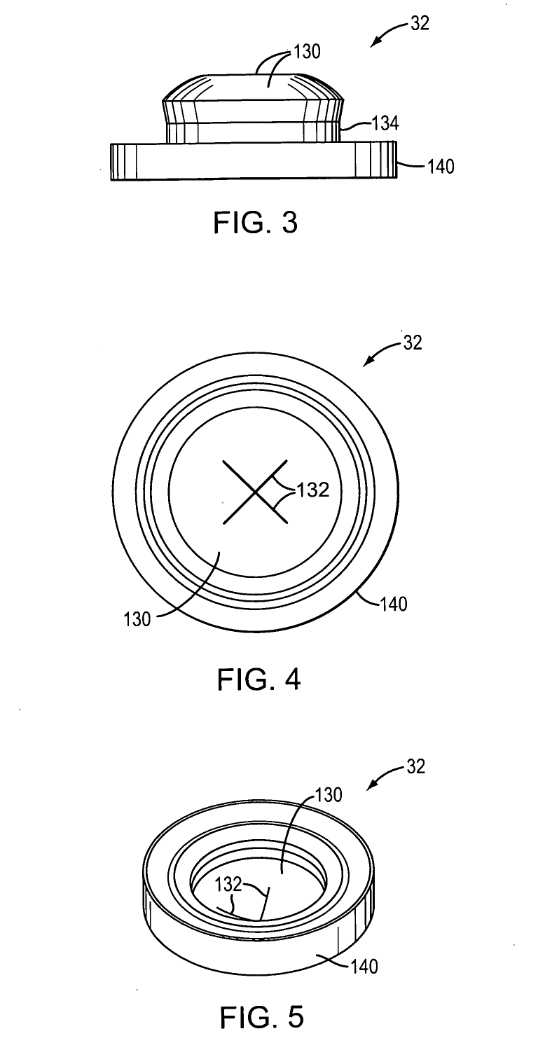

In operation, the valve member 32 changes configuration between (1) a closed, generally unstressed, rest position (FIG. 2), and (2) an active, open position (FIG. 6) when the valve member 32 is moved by the movement of the actuating member 30 in response to the user pressing the button 28 as described hereinafter. The valve member 32 includes a flexible, central portion or head 130 (FIGS. 3-5). When the valve member 32 is closed, the head 130 has a concave configuration (when viewed from the exterior of the dispensing system 20). The head 130 preferably has two, mutually perpendicular, planar, intersecting, dispensing slits 132 of equal length which together define a closed dispensing orifice when the valve is closed. The intersecting slits 132 define four, generally sector-shaped, equally sized flaps or petals in the concave, central head 130. The flaps are forced open outwardly from the intersection point of the slits 132 when the user pushes the dome actuator button 28 with a sufficient amount of force. The valve member 32 could be molded with the slits 132. Alternatively, the valve slits 132 could be subsequently cut into the central head 130 of the valve member 32 by suitable conventional techniques.

The valve member 32 includes an annular skirt or sleeve 134 which extends from the valve central wall or head 130. At the inner end of the sleeve 134, there is a thin, annular flange 138 which extends peripherally from the sleeve 134 in a reverse angled orientation when the valve member 32 is in the unactuated, rest condition. The thin flange 138 merges with an enlarged, much thicker, peripheral flange 140 which has a generally dovetail-shaped, transverse cross sectional configuration (as viewed in FIG. 6).

To accommodate the seating of the valve member 32 in the body 26, the top surface of the dovetail valve flange 140 has the same frustoconical configuration and angle as the frustoconical surface 124 of the body 26.

The other surface (i.e., bottom surface) of the valve flange 140 is clamped by the retaining ring 34 (FIG. 2). The retaining ring 34 includes an annular valve retention portion that defines an upwardly facing, frustoconical, annular clamping surface 152 (FIG. 6) for engaging the outwardly facing surface (i.e., bottom surface) of the valve flange 140 at an angle which generally matches the angle of the valve flange outwardly facing surface (i.e., bottom surface).

A peripheral portion of the retaining ring 34 includes an outwardly projecting shoulder or bead 158 (FIG. 6) for snap-fit engagement with an annular bead 160 that is located on the body 26 outwardly of the annular seat 124, and this snap-fit engagement causes the ring 34 to clamp the valve member 32 tightly in the body 26. During assembly, the retaining ring 34 can be pushed past the retaining bead 160 because there is sufficient flexibility in the retaining ring 34 and/or body 26 to accommodate temporary, elastic deformation of the components as the retaining ring bead 158 passes over, and inwardly beyond, the body bead 160 to create a snap-fit engagement that compresses or clamps the valve member 32 between the opposing frustoconical surfaces 124 and 152 (FIG. 6) This permits the region adjacent the interior surface of the valve sleeve 134 to be substantially open, free, and clear so as to accommodate movement of the valve sleeve 134 when the valve member 32 opens as will next be explained.

When the valve member 32 is properly mounted within the body 26 as illustrated in FIG. 2, the central portion or head 130 of the valve member 32 lies recessed inwardly away from the retaining ring 34. However, when the dome or button 28 is pressed to open the valve member 32, then the rod 30 forces valve head 130 outwardly from its recessed position to a location within the retaining ring 34 (FIG. 6).

As the valve member 32 is forced open, the outward displacement of the central head 130 of the valve member 32 is accommodated by deformation of the head 130 and of the relatively thin, flexible sleeve 134. The sleeve 134 deforms, or moves, from an inwardly projecting, rest position (shown in FIG. 2) to an outwardly displaced, actuated position, and this occurs by the sleeve 134 “rolling” along itself outwardly toward the discharge end of the system (toward the generally inverted position shown in solid lines in FIG. 6).

In the preferred embodiment of the valve member 32 illustrated for the preferred embodiment of the inventive dispensing valve assembly, the valve member 32 is designed to close when the user stops pushing on the button 28. The inherent resiliency of the button 28 causes it to return to the unactuated, undeformed rest configuration, and this pulls the actuating member 30 back up to the unactuated position and allows the valve member 32 to return to the unactuated, closed condition (by action of the force generated from the resilient valve's deformational stresses). The valve member 32 is sufficiently stiff to remain closed under the static head of the fluid in the reservoir 22, but the valve member 32 is flexible enough to open when the user pushes on the button 28 with a force of a convenient magnitude.

If the preferred form of the valve member 32 has also been designed to be flexible enough to accommodate in-venting of ambient atmosphere as described in detail below, then the closing petals of the valve can continue moving inwardly to allow the valve to open inwardly when the pressure on the valve head exterior surface exceeds the pressure on the valve head interior surface by a predetermined magnitude. For some dispensing applications, it may be desirable for the valve member 32 not only to dispense the product, but also to optionally accommodate such in-venting of the ambient atmosphere to help equalize the pressure in the reservoir 22 with the pressure of exterior ambient atmosphere. Such an in-venting capability can be provided by selecting an appropriate material for the valve construction, and by selecting appropriate thicknesses, shapes, and dimensions for various portions of the valve head 130 for the particular valve material and overall valve size. The shape, flexibility, and resilience of the valve head, and in particular, of the petals, can be designed or established so that the petals will deflect inwardly when subjected to a sufficient pressure differential that acts across the head 130 in a gradient direction toward the interior of the body 26. Such a pressure differential might occur after liquid is discharged from the reservoir 22 through the valve member 32, and a partial vacuum is created inside the reservoir 22. When the valve member 32 closes, if there is a partial vacuum in the reservoir 22, and if the pressure differential across the valve member 32 is large enough, the valve petals will deflect inwardly to permit in-venting of the ambient atmosphere into the reservoir 22 to assist in equalizing the internal pressure with the external pressure.

It is to be understood that the dispensing orifice of the valve member 32 may be defined by structures other than the illustrated slits 132. If the orifice is defined by slits, then the slits may have many different shapes, sizes and/or configurations in accordance with the dispensing characteristics desired. For example, the orifice may also include five or more slits.

If it is desired to provide particular dispensing characteristics, then the dispensing valve member 32 is preferably configured for use in conjunction with (1) the characteristics of the particular container 22 (e.g., the maximum height of the fluent substance product in the reservoir), (2) the characteristics of the particular fluent substance product, and (3) any relevant characteristics of the other dispensing system components. For example, the viscosity and density of the fluent product can be relevant factors in designing the specific configuration of the valve member 32. The rigidity and durometer of the valve material, and size and shape of the valve head 130, can also be relevant to achieving some desired dispensing characteristics, and can be selected to accommodate the size of the reservoir 22 and the characteristics of the substance to be dispensed therefrom.

In the preferred embodiment of the present valve assembly, the actuation member 30 includes a head portion 31 which defines at least one flow port 31′ through which liquid can flow from within the valve body 26 and through the valve member 32, when the valve member is in its open configuration. The illustrated embodiment also includes a pocket 29 on the interior surface of actuation button 28 for receiving an end portion of the actuation member 30. Actuation button 28 may be retained on the valve body by a suitable press fit, or may be more positively retained on the valve body such as by the provision of a snap-fit retention ring generally like valve retaining ring 34.

In accordance with the illustrated embodiment, the valve body 26 preferably defines first and second internal flow passages, with the first internal flow passage passing through collar 24, and with actuation member 30 reciprocably disposed within the second internal flow passage defined by the body 26. As shown, the preferred embodiment is configured such that the first and second internal flow passages defined by the body are arranged at a right angle (i.e., 90°).

From the foregoing, operation of the present dispensing valve assembly will be readily appreciated. Upon connection of the valve assembly to an associated container or like reservoir, liquid from within the reservoir enters the valve body through collar 24, with the closed configuration of valve member 32 preventing flow out of the body through the discharge opening thereof. When dispensing of liquid is to be effected, downward pressure on actuation button 28 by suitable manipulation thereof acts to urge actuation member 30 downwardly against the valve head of valve member 32, thereby resiliently deflecting and deforming the valve member generally by “rolling” inversion of intermediate sleeve portion 34. As the deformable regions of the valve head move away from each other, liquid flow from within the valve body is permitted. The provision of one or more flow ports 31′ in head portion 31 of the actuation member facilitates flow from within the valve body, and through the open valve member 32.

When it is desired to discontinue dispensing flow, release of actuation button 28 causes the button to resiliently resume its undeformed, generally upwardly extending configuration, with actuation member 30 reciprocating upwardly within the second internal flow passage of the valve body as the actuation member returns to its raised position. Release of pressure on the actuation button 28 permits a valve member 32 to return to its original, closed configuration, wherein the valve member extends generally upwardly into the valve housing of the valve body. The deformable regions of the valve head of the valve return to their closed orientation, with liquid flow through the valve member thus prevented.

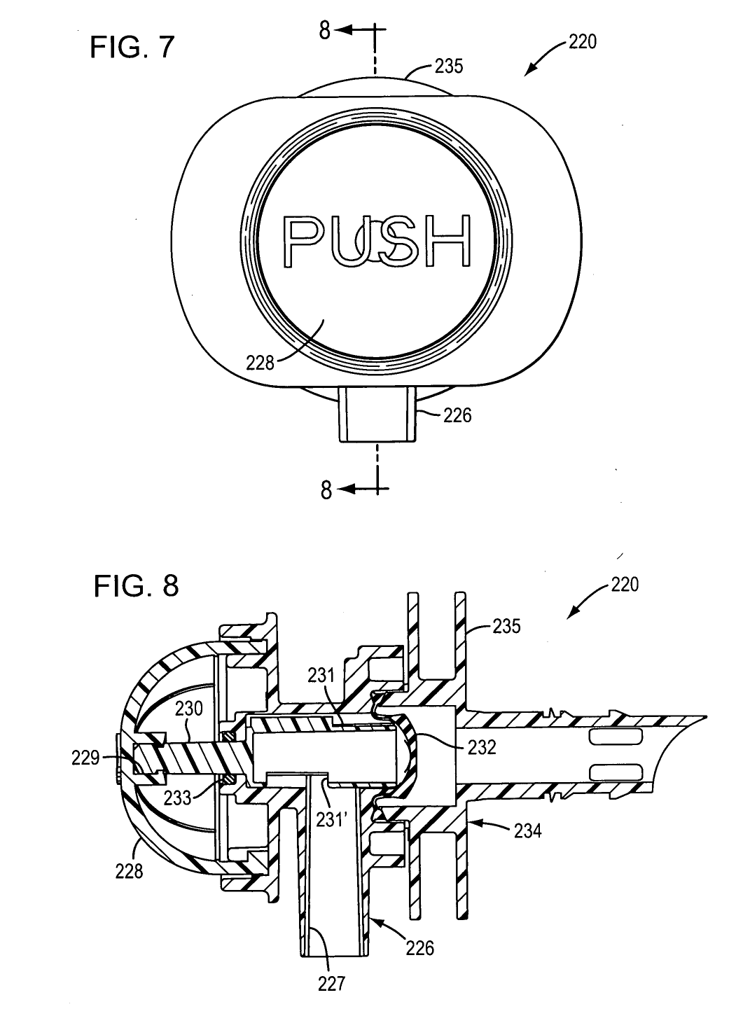

An alternate embodiment of the present dispensing valve assembly is illustrated in FIGS. 7 and 8, wherein components that generally correspond to the previously described embodiment are designated by like reference numerals in the 200-series. In many respects, this alternate embodiment is like the previously described embodiment, and includes a valve body within which a resiliently deformable valve member is provided for controlling liquid flow, with a reciprocable actuation member provided for engagement with the valve member to deflect and deform the valve member from a closed configuration to an open configuration. In distinction from the previous embodiment, this embodiment of the present invention is configured such that the actuation member is reciprocably moveable in a generally horizontal orientation, as opposed to a generally vertical orientation of the previous embodiment. Additionally, in this embodiment, the valve member is positioned generally upstream of the actuation member, rather than generally downstream thereof as in the previous embodiment.

With particular reference to FIGS. 7 and 8, therein is illustrated a dispensing valve assembly 220 which includes a valve body 226 which defines a downwardly open discharge opening 227. The valve assembly includes a reciprocably moveable actuation member 230 having a head portion 231 which defines a flow port 231′ which provides liquid flow through the valve body.

The actuation member 230 is reciprocably positioned within the valve body 226, in a generally horizontal orientation, with an actuation button 228 provided on the exterior of the valve body 226, with the actuation button being engageable with the actuation member 230. By this arrangement, manipulation of the actuation button reciprocably moves the actuation member 230.

In accordance with the present invention, the valve assembly 220 includes a valve member 232 which can be configured in accordance with the valve member 32 of the previously-described embodiment. However, in distinction from the previous embodiment, valve member 232 is maintained in a non-inverted configuration during operation of the valve assembly.

As illustrated, the head portion 231 of the actuation member 230 fits generally within the valve member 232, whereby movement of the actuation member toward the right, referring to the orientation of FIG. 8, acts to generally deform and deflect the valve head of the valve member 232 to permit liquid flow therethrough. Because the valve member 232 is positioned generally upstream of the actuation member 230, liquid flow through the valve assembly is provided through the valve member 232, then through flow port 231′ of head portion 231 of actuation member 230, and out of discharge opening 227.

Actuation button 228 includes a pocket 229 on an interior surface thereof for receiving an end portion of actuation member 230. If it is desired to limit flow of liquid from within the valve body into the region generally inside of the actuation button 228, the valve assembly can be provided with a suitable seal, such as O-ring 233 which engages the rod-line portion of the actuation member 230.

In this embodiment, a valve retaining member 234 is provided for holding the valve member 232 in position within the valve body 226. In this embodiment, the valve retaining member 234 includes a collar 235 for connecting the valve assembly to an associated container.

Consistent operation of the valve assembly 222 can be enhanced by the provision of an anti-inversion feature on the valve body 226, which feature fits generally within the deformable valve 232. This feature can take the form of a generally ring-like element which extends from the valve body 226 generally into the valve member 232. The provision of this feature can act to prevent inversion of the deformable portions of the valve 232, with the understanding that in this embodiment of the present valve assembly, it is contemplated that the valve member 232 be maintained in a non-inverted configuration.

From the foregoing, the operation of this embodiment of the present valve assembly will be readily appreciated. By depressing and deforming the actuation button 228, the actuation member 230 is moved so as to engage and deform the valve head of the valve member 232, thereby opening the valve member to permit liquid flow therethrough. By virtue of the disposition of the valve member 232 generally upstream of the actuation member 230, liquid flows through the valve member, then through the flow port 231′ of head portion 231 of the actuation member, and out of discharge opening 227 defined by the valve body.

Upon release of actuation button 228, the resilience of the button acts to move the actuation member 230 to its initial, rest position, as generally shown in FIG. 8. Attendant to this movement, the deformable portions of the valve member 232 move into cooperative sealing engagement with each other, with the valve member thus moving from an open configuration to a closed configuration. Flow through the valve assembly is thus terminated.

It will be readily observed from the foregoing detailed description of the invention and from the illustrations thereof that numerous other variations and modifications may be effected without departing from the true spirit and scope of the novel concepts or principles of this invention.

1. A dispensing valve assembly for controlling flow from an associated container, said dispensing valve assembly comprising:
a dispensing valve body defining an internal flow passage for receiving fluid from said associated container, said valve body further defining a flow discharge opening;
a flow-control valve member positioned within said dispensing valve body for controlling flow within the valve body and out of said valve body through said flow discharge opening,
said valve member including a peripheral attachment portion by which said valve member can be attached to said dispensing valve body, a flexible, resilient, intermediate portion extending from said peripheral attachment portion, and a central valve head, extending from said intermediate portion, at least part of said valve head being outwardly deflectable from a closed configuration to an open configuration of said valve member,
said valve head including at least one elongate slit defining at least two, deformable openable regions, and
an actuation member positioned within said valve body for reciprocating movement with respect to said valve body, said actuation member being engageable with said valve head of said valve member for moving said valve head from said closed configuration to said open configuration.

2. The dispensing valve assembly in accordance with claim 1, including a valve retaining member having an annular valve retention portion, said valve member being positioned in captive relationship between said valve body and said annular valve retention portion of said valve retaining member.

3. The dispensing valve assembly in accordance with claim 1, including an actuation button provided on the exterior of said valve body, and being engageable with said actuation member, so that manipulation of said actuation button reciprocably moves said actuation member to act against said valve member to move said valve member from said closed configuration to said open configuration.

4. The dispensing valve assembly in accordance with claim 3, wherein said actuation button includes a pocket on an interior surface thereof for receiving an end portion of said actuation member.

5. The dispensing valve assembly in accordance with claim 1, wherein said actuation member includes a head portion engageable with said valve member, said head portion defining at least one flow passage to permit flow from with said valve body, through said head portion, and through said valve member in the open configuration thereof.

6. A dispensing valve assembly in accordance with claim 1, wherein said valve body includes a connecting collar for connection to said associated container, and defines first and second internal flow passages, said first flow extending through said connecting collar, said second flow passage being joined in fluid communication with said first flow passage downstream of said connection collar,
said actuation member being positioned within said second flow passage.

7. A dispensing valve assembly in accordance with claim 6, wherein said first and second internal flow passages are arranged at a right angle to each other.

8. Dispensing valve assembly in accordance with claim 1, wherein said intermediate portion of said valve member comprises a rolling, invertible sleeve.

9. A valve assembly in accordance with claim 1, wherein said peripheral attachment portion of said valve member has a dovetail-shaped cross-sectional configuration.

10. A dispensing valve assembly in accordance with claim 2, wherein:
said valve retaining member includes a collar for connecting said valve assembly to an associated container.

11. A dispensing valve assembly in accordance with claim 1, wherein:
said valve member is positioned within said valve body generally downstream of said valve actuation member.

12. A dispensing valve assembly in accordance with claim 5, wherein:
said valve member is positioned within said valve body generally upstream of said valve actuation member, so that liquid from said container flows through said valve member and then through said flow port and out of said discharge opening of said valve body.

13. A dispensing valve assembly in accordance with claim 12, wherein:
said valve member is maintained in a non-inverted configuration.

14. A dispensing valve assembly for controlling flow from an associated reservoir, said dispensing valve assembly comprising:
a dispensing valve body defining first and second internal flow passages joined in fluid communication with each other, said valve body including a connecting collar for connection to an associated reservoir, said first passage extending through said connecting collar, said valve body defining a flow discharge opening of said valve body;
a flow-controlling valve member positioned within said valve housing of said dispensing valve body for controlling flow from said first and second flow passages through said flow discharge opening,
said valve member including a peripheral attachment portion by which said valve member can be attached to a dispensing valve body, a flexible, resilient, intermediate portion extending from said peripheral attachment portion, and a central valve head extending from said intermediate portion, at least part of said valve head being outwardly deflectable to an open configuration of said valve member when a sufficient pressure differential exists across said valve assembly to permit flow from said first internal flow passage through said flow port and said central flow passage to said second internal flow passage, said valve head including at least one elongate slit defining at least two, deformable openable regions which each (1) has at least one transverse face for sealing against a transverse face of another one of said openable regions, and (2) is normally closed but can open to permit flow therethrough;
a valve retaining member having an annular valve retention portion, said valve member being positioned in captive relationship between said valve housing and said annular retention portion of said valve retaining member;
an actuation member positioned within said valve body for reciprocating movement within said second internal flow passage of said valve housing of said valve body, said actuating member being engageable with said valve head of said valve member for moving said valve head from said closed configuration to said opening configuration; and
an actuation button provided on the exterior of said valve body, and being engageable with said actuation member, so that manipulation of said actuation button reciprocably moves said actuation member to act against said valve member to move said valve member from said closed configuration to said open configuration to permit flow through said valve body of said valve assembly.

15. A dispensing valve assembly in accordance with claim 14, wherein said actuation member includes a head portion engageable with valve member, said head portion defining at least one flow passage to permit flow from within said valve body, through said head portion, and through said valve member in the open configuration thereof.

16. A dispensing valve assembly in accordance with claim 15, wherein said intermediate portion of said valve member comprises a rolling, invertible sleeve.

17. A dispensing Valve assembly in accordance with claim 15, wherein:
said valve member is positioned within said valve body generally upstream of said valve actuation member, so that liquid from said container flows through said valve member and then through said flow port and out of said discharge opening of said valve body.
